(19) United States
(12) Patent Application Publication
(10) Pub. No.: US 2015/0128110 A1
(43) Pub. Date: May 7, 2015

(54) MOBILE APPLICATION DEVELOPMENT AND DEPLOYMENT

(71) Applicants: Alexander Falk, Marblehead, MA (US); Vladislav Gavrielov, Wien (AT)

(72) Inventors: Alexander Falk, Marblehead, MA (US); Vladislav Gavrielov, Wien (AT)

(21) Appl. No.: 14/072,106

(22) Filed: Nov. 5, 2013

(51) Int. Cl. H04L 29/08; G06F 11/36; G06F 17/22

(52) U.S. Cl. CPC H04L 67/10; G06F 17/2247; G06F 11/3636
USPC 717/128; 709/203

(57) ABSTRACT

Methods and apparatus, including computer program products, for mobile application development and deployment. A method includes, in a server residing in a network, receiving an application description file from a design system communicatively linked to the server, the application description file capable of targeting multiple application platforms and representing a workflow of an application for user equipment communicatively linked to the server, generating from the received application description file an application envelope comprising at least a subset of the application description file, and sending the application envelope to a client application residing in the user equipment, the client application interpreting contents of the application envelope.

### BACKGROUND OF THE INVENTION

The invention generally relates computer systems and computer executed methods, and more specifically to mobile application development and deployment.

The furious rate of technological change and growth in the mobile market has made it very challenging for developers to strategically plan a project, not only from a technical standpoint, but also because the market share for smart phones is changing rapidly between different systems.

Mobile application development is a process by which application software is developed for handheld devices, such as personal digital assistants, enterprise digital assistants or mobile phones. These applications can be pre-installed on phones during manufacturing, downloaded by customers from various mobile software distribution platforms, or delivered as web applications using server-side or client-side processing (e.g., JavaScript®) to provide an “application-like” experience within a Web browser. However, mobile application development and deployment are complicated because application software developers have to consider at least a lengthy array of screen sizes, hardware specifications and configurations, and operating systems of a variety of mobile application platforms.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides methods and apparatus, including computer program products, for mobile application development and deployment.

In general, in one aspect, the invention features a method including, in a server residing in a network, receiving an application description file from a design system communicatively linked to the server, the application description file capable of targeting multiple application platforms and representing a workflow of an application for user equipment communicatively linked to the server, generating from the received application description file an application envelope comprising at least a subset of the application description file, and sending the application envelope to a client application residing in the user equipment, the client application interpreting contents of the application envelope.

In another aspect, the invention features an application design debugging process including, in a design system residing in a network, generating an application description file, the application description file capable of targeting multiple application platforms and representing a workflow of an application for user equipment communicatively linked to a server, generating from the application description file an application envelope including at least a subset of the application description file, and debugging a design of the application envelope. Debugging can occur in the design system, in the server, and on user equipment.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

The invention will be more fully understood by reference to the detailed description, in conjunction with the following figures, wherein:

FIG. 1 is a block diagram of a system.

FIG. 2 is an exemplary graphical user interface (GUI).

FIG. 3 is an exemplary graphical user interface (GUI).

FIG. 4 is an exemplary graphical user interface (GUI).

FIG. 5 is an exemplary graphical user interface (GUI).

FIG. 6 is an exemplary graphical user interface (GUI).

FIG. 7 is an exemplary graphical user interface (GUI).

FIG. 8 is an exemplary graphical user interface (GUI).

FIG. 9 is an exemplary graphical user interface (GUI).

FIG. 10 is an exemplary graphical user interface (GUI).

FIG. 11 is an exemplary graphical user interface (GUI).

FIG. 12 is an exemplary graphical user interface (GUI).

FIG. 13 is an exemplary graphical user interface (GUI).

FIG. 14 is an exemplary workflow.

FIG. 15 is a flow diagram.

FIG. 16 is a flow diagram.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “system,” “platform,” and the like can refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

In addition, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

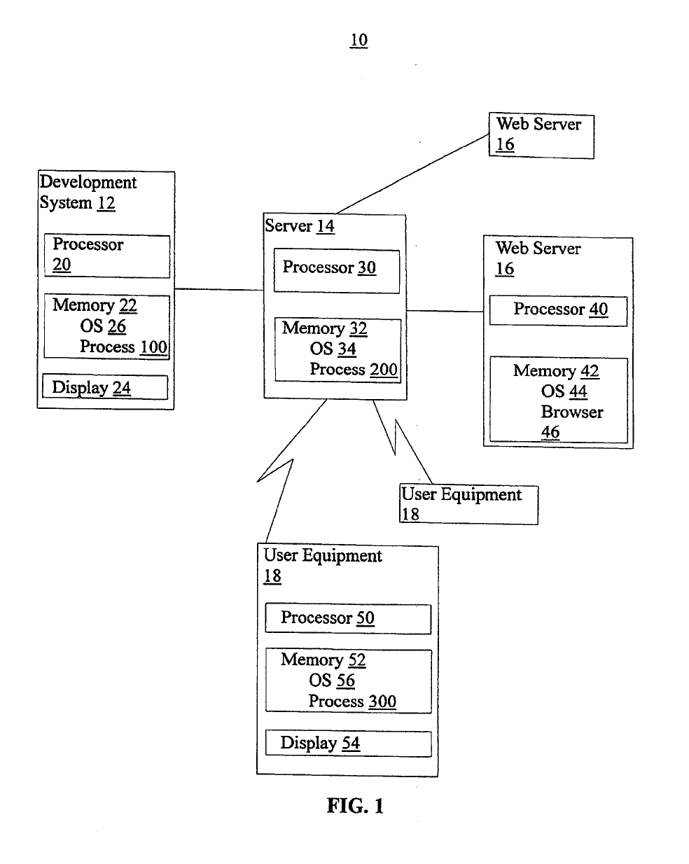

As shown in FIG. 1, an exemplary system 10 includes development system (also referred to as a “design system”) 12 communicatively linked to a server 14. The server 14 is communicatively linked to one or more web servers 16 and one or more client devices (also referred to as “user equipment”) 18. The link between the server 14 and the one or more client devices 18 can be wired or wireless.

The development system 12 includes at least a processor 20, a memory 22 and a display 24. The memory 22 can include an operating system (OS) 26, such as Windows®, MacOS® or Linux®, an application design process 100 and an application design debugging process 150. The application design process 100, more fully described below, enables the generation of an application description file that is capable of targeting multiple application platforms and represents a workflow of an application for client devices 18. The application design debugging process 150, more fully described below, enables debugging of the application description file by simulating its behavior on the development system 12, the server 14 and/or the client device 18.

The server 14 includes at least a processor 30 and a memory 32. The memory 32 includes an operating system 34 and an application conversion and deployment process 200. The application conversion and deployment process 200, more fully described below, generates an application envelop from a received application description file and includes at least a subset of the application description file.

Each of the one or more web servers 16 includes a least a processor 40 and a memory 42. The memory 42 includes an operating system (OS) 44, such as Windows®, MacOS® or Linux®, and web browser 46.

Each of the one or more client devices 18 includes at least a processor 50, a memory 52 and a display 54. The memory 52 includes an operating system 56, such as Windows® Mobile, Apple iOS®, Android® or Linux®, and a mobile application 300. The user equipment 18 can include, for example, a smartphone, a tablet computer, a hybrid smartphone/tablet computer, a personal data assistant (PDA), a netbook computer, a laptop computer, a personal computer, a desktop computer, servers, wearable computers, Google® Project Glass, and so forth. The mobile application 300, more fully described below, communicates with the application conversion and deployment process 200 residing in the server 14.

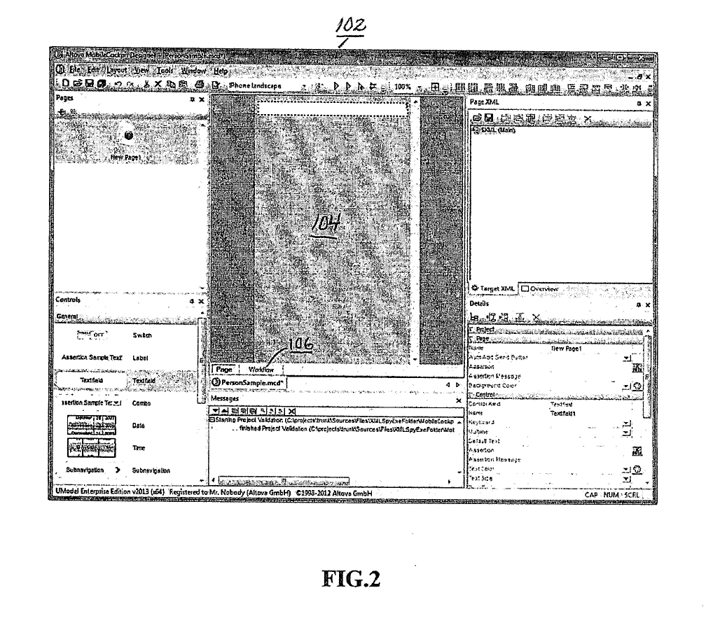

As described above, the application design process 100 enables the generation of an application description file that is capable of targeting multiple application platforms and represents a workflow of an application for client devices. As shown in FIG. 2, the application design process 100 begins by generating a graphical user interface (GUI) 102 that displays a design of a selected page or a workflow for a complete document depending on a tab selection. A toolbar enables changing a target (and can also include page aspect ratio and screen size). Beside the target there is a play button that is used to open a current page (without workflow) in a Page Preview 104. Additionally, when in the workflow tab 106, the play button leads to a Simulator (including workflow). Double clicking a page leads to a page design editor.

On a left hand side there is an entry helper list of all pages in the document. Some add/remove buttons may be included in implementations.

There is an entry helper that shows a detail of the selected page/table/column/control.

There is an entry helper containing the controls available for dragging into the view (e.g., changes on target selection)

There is an entry helper that shows the working extensible markup language (XML) that is used to populate the page. This XML structure can be manually created by using the buttons on top for creating elements or attributes or loading an existing XML with the open button. Bold items in the tree are already associated with some control in the view. The XML structures can be manually edited, come from a sample XML or read from database tables.

To avoid a “blank page phenomenon” where a user sits in front of an empty view, process 100 guides the user with small messages. Fields that result in creating a new line when dropping elements on them receive a small hint text.

The user is able to toggle the visibility of these “insertion helper” fields to gain a better overview.

In one implementation, unassociated controls in the view get a small icon as a hint, such as “data connection might be missing.” This icon is only displayed if no fixed value (e.g., text) is entered and no XML association is there and there is no Xpath statement evaluating this field.

Selecting something in the main view selects the corresponding item in the XML data tree and vice versa. The entry helper for this control also shows what XML path will be created.

In summary, the GUI 102 shows a list of controls that are rendered one below each other. A control can be a table (a table consists of controls) or a dynamic table, which resembles a table, but is created once for every occurrence of an element. Dynamic tables can grow and shrink by user interaction.

Controls are available in two groups, i.e., device independent and device dependent. Device independent controls include Switch, Label, Edit field, Combo, Datepicker, Timepicker, Sub navigation (go to a page “deeper” in the hierarchy with the possibility to go up again via a back button—alters same XML as the parent page), Image, Table (can be static or recurrent) and Chart. Device dependent controls include DateTimepicker (for iOS® and Web) and CheckBox (for Android® and Web).

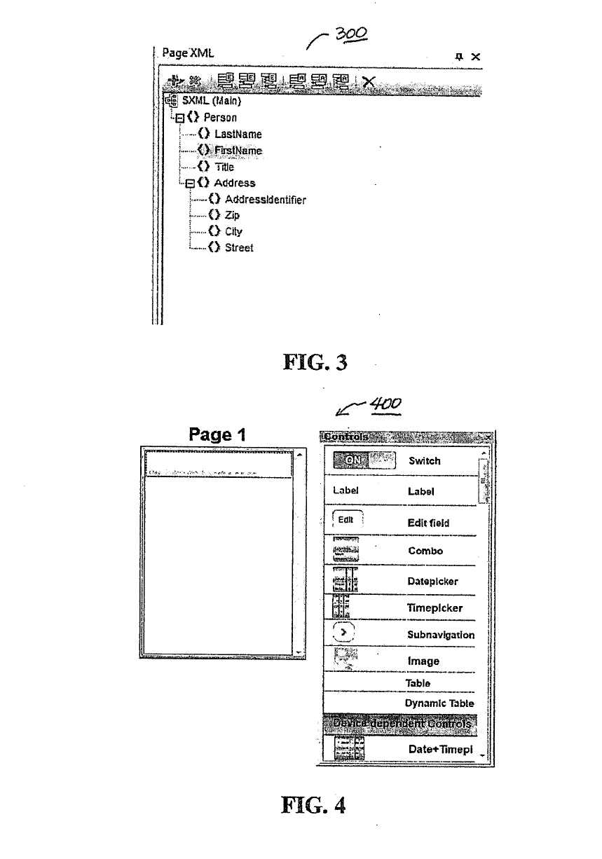

Process 100 starts with an empty page and no source/target XML. As shown in FIG. 3, the XML is opened in an entry helper window 300.

As shown in FIG. 4, a control view 400 is displayed and the user prompted to drag some control for a new line.

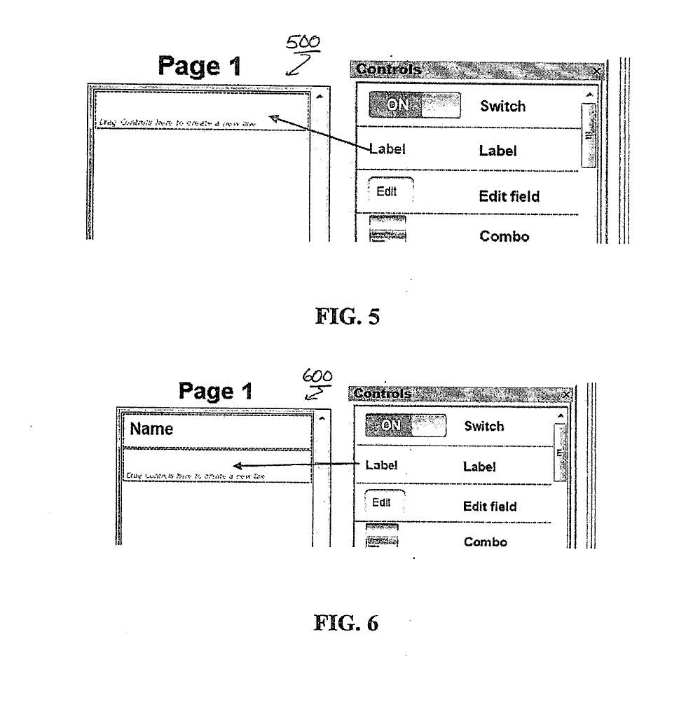

As shown in FIG. 5, as soon as the user drags a control the label is changed in the GUI 500.

Next, a name/value table is created by either dragging a table into the view or creating a table indirectly. As shown FIG. 6, the user drags a Label in the GUI 600 into the newly added placeholder for an empty line and process 100 renames the label to a proper value, i.e., title in this example.

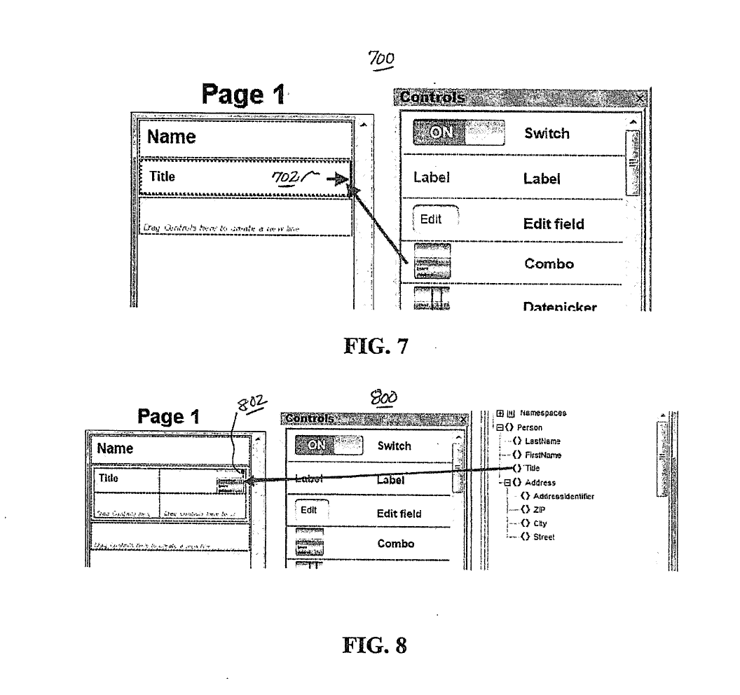

As shown in FIG. 7, dragging a combo control in GUI 700 into a colored arrow position 702 signals a position where a table column will be added. When the user drops, a static table is obtained.

As shown in FIG. 8, an exclamation point 802 in GUI 800 indicates that a data connection may be missing and the user should drag an element or attribute on this control to create a data connection. Dragging a title solves the problem.

The screens illustrated in FIGS. 2-8 are only a prediction of how they may look because of the type and properties of the display 24. Accordingly, the columns have properties to define their width and sizing behavior. For example, the user can select the percentage of the width for each column or choose “fit to content,” which checks the maximum extent of all cells in this column and takes the maximum width.

Process 100 includes a “control width” flag in the entry helper to express the width of a control within a parent. This parent restricts the maximum width and can either be the page itself (then the maximum size is the page width) or a table's cell.

An image's content size is normally the image size in pixels. For a chart, the “Chart Creation Width” and “Chart Creation Height” details define the size that is used for ^{“}wrap content”.

A user may want to enter multiple Title/Name pairs. All that is needed is a user selection from the Properties window and a user selection of “repeating.” Process 100 then marks the table as dynamic.

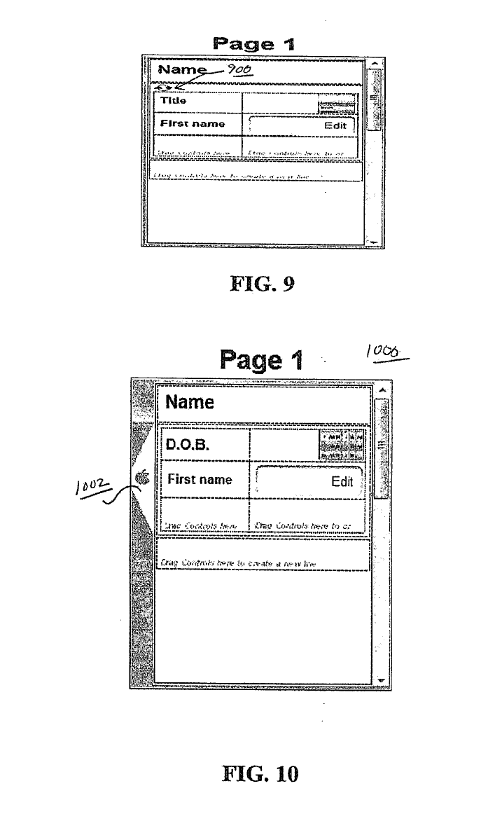

As shown in FIG. 9, a small circle 900 appears in one color if no data association for the reoccurring element was created, and another color when there is a data association. Dragging the XML element from the page XML entry helper to the table is enough to create the dynamic table.

The dynamic table means that for every occurrence of the recurrent element, the complete table will be created in the target application. And also for every newly added “row,” a new XML element will be created in the output XML.

In some cases, a user may try to use controls that are only available on one specific device and not on another. Process 100 displays an operating system (OS) specific symbol beside the table/control. When adding a control that is only available on one device this device dependency is automatically turned on for this control/table.

These “device dependent” lines are only rendered on the devices that are marked. Lines without device dependencies are rendered on all devices.

A user can manually add a device dependency to a table or a control. This is done via the context menu or toolbar.

In an example GUI 1000 shown in FIG. 10, a datetime picker (iPhone® only) was added to the table. Therefore the whole table was automatically marked as iphone only 1002.

Additionally, the user has the option to choose the result of “user variables” that can be evaluated by Xpath as flag if a line should be shown or not.

The user sees which global Xpath variables are defined during runtime and that he can define his own user variables based on Xpath statements. These user statements or Global Variables can then be used in Xpathes or for showing/hiding lines depending on the Xpath results.

In sub-navigation, the XML created by and parsed by these subpages has the same structure but different “root” elements for every context where it occurs. The root elements for this page are provided during execution by the parent page. Process 100 has two different options, i.e., create the subpage from within the main page or create subpage without a parent page.

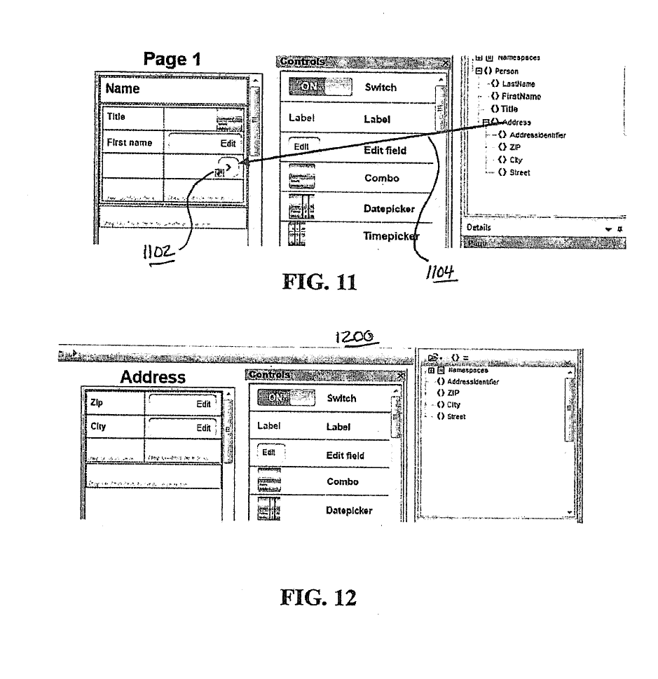

In the first option, as shown in FIG. 11, on Page 1, process 100 creates a sub-navigation button 1102 that leads to the address page and assigns the “Address” target element to it as “subpage root element.”

This added data association means that the called subpage receives this Address element as “root” when opening the subpage during execution. The arrow 1104 means that no page association is set for this sub navigation button. A tooltip tells the user what he can do: “drag an existing page on this button”, “create a subpage for this button in the context menu,” reuse the XML of the main page. When the user clicks yes, it leads automatically to the same action as the context menu entry would have done, i.e., a new page is created—called “subpage xx,” the XML elements for this page are automatically set, the button gets associated with the newly created subpage, and the main view “jumps” to the subpage for editing. Process 100 creates the address fields and associates the XML with the edit fields. The result of the subpage is shown in FIG. 12 in GUI 1200.

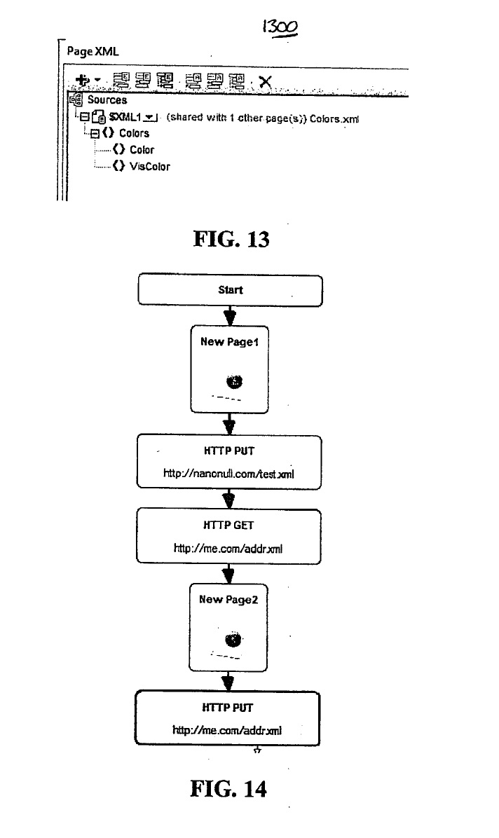

A user may need to use the same xml structure for multiple different pages. Process 100 uses the name ($xml) to reuse structures on different pages. When a user adds a new page XML (Page XML entry helper/+button/add xml data), the user can choose with the combo beside the XML structure name a structure that should be reused from a different page. FIG. 13 illustrates that an entry helper 1300 shows the user on which pages this structure is also used.

When adding a db-XML, the user can choose either complete tables or custom select statements that can have parameters.

Each one of the read only XMLs might only be used within a server for chart generation. The data for this can come from a large database. Process 100 specifies on every read-only XML via a context menu, if the XML is sent to the client or if it's kept on the server only. This is visually reflected by an overlay icon over the XML document or the database icon.

Process 100 generates a workflow. In general, workflow is a term used to describe the tasks, procedural steps, organizations or people involved, required input and output information, and tools needed for each step in a business process. For example, an insurance company could use a workflow to ensure that a claim was handled consistently from initial call to final settlement. The workflow would ensure that each person handling the claim used the correct online form and successfully completed their step before allowing the process to proceed to the next person and procedural step.

Process 100 includes connections and data processors. Data processors do work, i.e., something that takes data and/or generates data. Connections represent the flow (execution path) between the processors and are represented via lines.

With respect to data processors, input means that this data processor takes some input data to process. Output means that it generates some output on its own.

Connections carry XML data. Some of the connections may have additional information drawn at the end of the line to represent extra information only true for this one connection.

A simple workflow is illustrated in FIG. 14, wherein a user enters new person values, stores them to the web, opens some address information from the web, displays it in a second view, and stores this information on the web.

A workflow event is a way to move from one process in the workflow to another process and take the current working XML along. The simplest example of a workflow event is the send button on a page, which triggers a standard send event. The page exits on the bottom of the current page's process in the workflow and then follows the connection that originates from there.

As described above, process 100 stores an application description file including workflow definitions.

The workflow definitions include one or more of loading and saving of data files, executing workflows jobs on a separate workflow server (e.g., Flowforce™ from Altova GmbH, an easy-to-use management and automation tool for data conversion and integration tasks), branches in the workflow via XPath expressions, event handling within a page and in the workflow between pages, and grouping of pages. The application description file is capable of targeting multiple application platforms and represents a workflow of an application for client devices. The targeted application platforms can include, for example, Android®, iOS®, RIM®, Windows®, Linux®, Unix® and so forth.

It should be noted that process 100 can use XPath as an expression language for everything from calculations to conditional formatting to chart generation. For example, for every XML element a user can supply a default value as a fixed string, but process 100 enables the user to set a default value as a calculated value via an XPath expression.

For all combo-boxes, the user can specify a list of values displayed to the user as well as the data behind those values that is then entered into XML elements.

Most properties of the various design elements, e.g., colors, background colors, visible, editable, can be controlled dynamically via XPath expressions. For example, a textual hint or message can be displayed only if a certain condition in the data is fulfilled, or an element can be shown in bold-face or red depending on another condition. This is similar to how a user can use conditional formatting in Microsoft Excel® to color negative values in red and positive values in black. Process 100 does that same thing using XPath.

Process 100 can use Xpath to control all aspects of chart creation, including the data selected, the styles applied, as well as the actual iteration over the data.

Global variables in process 100 can be defined with initial values determined by XPath expressions.

It is possible in process 100 to express certain validation rules as assertions that are expressed in Xpath. For example, input value constraints, e.g., one could build a mortgage calculator application and then specify that the loan duration has to be between 1 and 30 years. This can be checked with an XPath expression, and if the check fails, a customer error message is displayed to the user.

In response to any button click, it is possible to use XPath expressions to set certain XML data elements to certain values. For example, complex calculations can be performed via XPath in response to button actions.

It is possible to design a workflow that proceeds along different execution paths depending on the result of a calculation expressed via Xpath.

If the workflow includes data from a database server, then the query sent to the database server can include calculations that are done in Xpath.

If the workflow includes items received from HTTP requests (e.g., REST-based or other web services), then any HTTP GET request query string parameters (i.e., the things after the question mark in an URL) can be specified via XPath expressions. For example, depending on user input, the server can then fetch data from another web service using the data entered by the user as part of the query string. It is also possible to modify a base-URI of such an HTTP request using Xpath.

Implementations of process 100 and 200 may include, and are not limited to, one or more of the following features.

It is possible for a developer to specify in that a workflow needs to include certain persistent variables or XML data that will be stored on each client device persistently across sessions. This is similar to how browsers use cookies to persistently store information on a users browser between website visits.

A Client can execute the workflow by himself (when no new XML, chart or image has to be accessed for the next page). Process 100 enables a shared execution model for the workflow, meaning that when the client app knows it does not need any additional data from the server (or doesn't need the server to render images or charts), it can proceed along the workflow steps on its own until it encounters a step where it has to go back to the server, so even for a process involving multiple pages of information displayed or input on the client, the client can do all of that independent of the server until a workflow step is reached where the data needs to be sent back to the server. This is done dynamically and transparently for the developer, to optimize the speed of the user experience.

XML elements/attributes can be “temporary,” i.e., not saved, which is useful for having temporary variables in a workflow.

Process 100 enables a user to verify that XML elements/attributes exist, which is necessary especially for temporary XML elements so that they can then be bound to user interface elements in the design.

XML elements/attributes can get default values (fixed or by using Xpath).

XML files/Images can be deployed together with the “application description file.” In the past, it was necessary for XML data files, as well as any images, to always be available to the server and client separately through a publicly accessible web server or FTP server. Now the developer can deploy these “accessory files” directly from process 100 and process 200 and they can be used in the workflow. This makes deployment so easier and faster.

Process 100 includes “debugging” possibilities of the simulator, e.g., every step traces all events/changes, XPath can be evaluated with simulation XML at any time during simulation, and so forth. This enables the developer to understand what's going on when they simulate the workflow even before deploying it to the server or to testing it on the clients.

In addition to using XML data files without a corresponding XML schema specification, process 100 can load XML Schema (XSD) documents to define the data structure of the workflow XML data.

As described above, data for the application can include one or more Extensible Markup Language (XML) files containing user input and modifications to the one or more XML files that was originally sent from the server to the client. The client application can be a mobile application in the user equipment or a HyperText Markup Language (HTML) browser in the user equipment.

Process 150 generates (160) from the application description file an application envelope including at least a subset of the application description file.

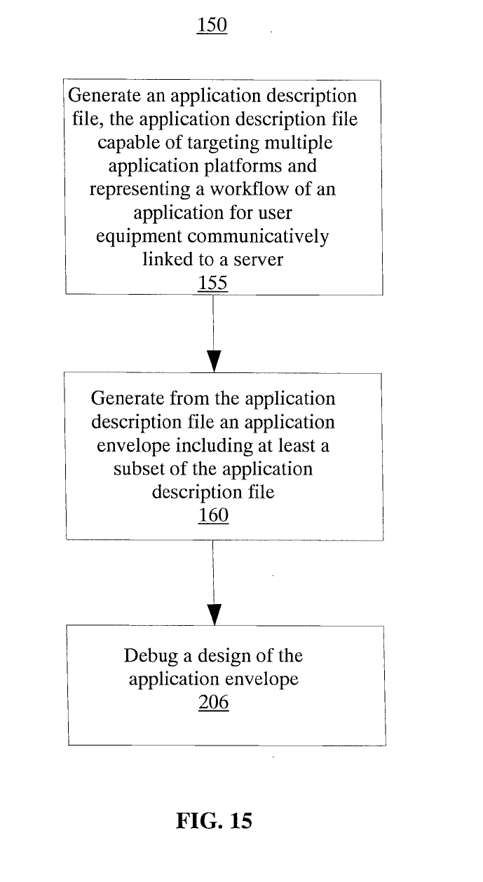

Before the application description file is sent to the server 14, a developer may debug the file and its behavior by simulating its execution on the development system 12, the server 14 and/or the client device 18. As shown in FIG. 15, the application design debugging process 150 includes, in a design system residing in a network, generating (155) an application description file, the application description file capable of targeting multiple application platforms and representing a workflow of an application for user equipment communicatively linked to a server.

Process 150 debugs (165) a design of the application envelope.

Debugging (165) the design of the application envelope can include executing the application envelope in the design system and displaying a trace of each of the steps in the workflow, the trace including a location of each step in the workflow and page source corresponding to the location.

Debugging (165) the design of the application envelope can include sending the application envelope to the server, executing the application envelope in the server, and displaying a trace of each of the steps in the workflow, the trace including a location of each step in the workflow and page source corresponding to the location.

Debugging (165) the design of the application envelope can include sending the application envelope to a client application on residing in the user equipment, executing the client application, and displaying a trace of each of the steps in the workflow, the trace including a location of each step in the workflow and page source corresponding to the location.

This application description file is sent to the application conversion and deployment process 200 residing in the server 14.

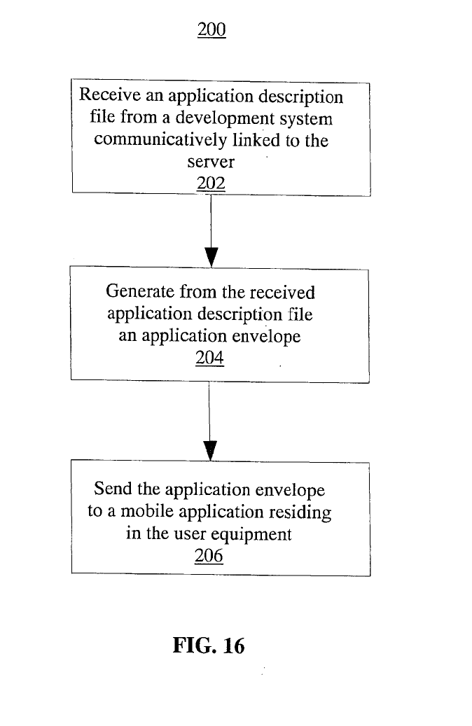

As shown in FIG. 16, the application conversion and deployment process 200 receives (202) the application description file from the development system communicatively linked to the server, the application description file capable of targeting multiple application platforms and representing a workflow of an application for user equipment communicatively linked to the server.

The application conversion and deployment process 200 generates (204) from the received application description file an application envelope including at least a subset of the application description file. Generating (204) the application envelope can include removing one or more of username/password information, chart settings, uniform resource locators (URLs) for data sources and FlowForce™ job settings.

The application envelope may be encoded in JavaScript Object Notation (JSON).

The application envelope may also include one or more of a unique identification (ID) of the workflow, version information about the server and protocol version, data for the application, one or more charts rendered by the server and saved as images, a pointer to a first or next page in the workflow to tell the client application what to do next, status information and a list of available workflows if the client application has requested such a directory from the server. Further, the client gets all the necessary information that he can partly execute the workflow by himself, and decide if he must go to the server by himself.

In implementations, the application envelope can include interpretedable user interface elements for the targeted application platforms, and/or interpretedable workflow definitions representing the application in the server and the application platforms and user equipment.

The application file may be specifically targeted at the capabilities of the user equipment reported to the application conversion and deployment process 200 by the mobile application 300.

The application conversion and deployment process 200 sends (206) the application envelope to the mobile application 300 residing in the user equipment, the mobile application 300 interpreting the contents of the application envelope.

The application conversion and deployment process 200 may render charts and images for the mobile application 300 in response to the workflow and to events sent from the mobile application 300.

Mobile application 300 in the user equipment communicates (e.g., via XML) with the application conversion and deployment process 200 in the server. Upon receiving the application envelope, the mobile application 300 interprets contents of the application envelope. In implementations, process 300 interacts with a user of the user equipment.

Mobile application 300 may send an envelope to process 200 in the server, the envelope including one or more of version information about a protocol version and a client version, a globally unique identifier (GUID), an operating system (OS) version, a manufacturer, a screen resolution, a tablet or smartphone indicator, a username/password, a user language, event information about a last event that happened on the client, data for the application, and/or request information from client to the server to handle special cases. This envelope from the mobile application 300 may be encoded in JavaScript Object Notation (JSON).

The mobile application 300 residing in the user equipment and the application description file residing in the server may include layout characteristics of the user equipment.

Other implementations may include one or more the following features. One can define a list of project wide “Behavior Groups” which contain of a list of other groups and nodes to update XML data. The groups can be used in any combination with “normal” node-action pairs in the existing control behavior dialog. Per default, when opening the Group dialog, the process shows the main XML tree of the current page. As everywhere, the main XML root of the page is the default context node for the XPathes defined in the Group.

The control behavior dialog enables conditional loading of charts/images/$XMLs.

In some implementations, the page behavior dialog is extended by three new events, i.e., on first page load, on every page load, and on page refresh. When pressing one of the “. . . ” buttons, the “control” behavior dialog with all its possibilities is opened.

A dialog, which is now used for page and control behavior, is extended with “Reload whole page” trigger and a “scroll to page bottom” functionality. For controls on sub-pages, a “return from subpage” trigger is added. Triggers, which make no sense for a specific event, are disabled (e.g., “Workflow event” for the “page load” events).

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
in a server residing in a network, receiving an application description file from a design system communicatively linked to the server, the application description file capable of targeting multiple application platforms and representing a workflow of an application for user equipment communicatively linked to the server;
generating from the received application description file an application envelope comprising at least a subset of the application description file; and
sending the application envelope to a client application residing in the user equipment, the client application interpreting contents of the application envelope.

2. The method of claim 1 wherein the application envelope is extended markup language (XML) packed into JavaScript Object Notation (JSON).

3. The method of claim 1 wherein the client application interpreting contents of the application envelope further comprises interacting with a user of the user equipment.

4. The method of claim 1 wherein the application description file includes XPath expressions that enable a developer to dynamically define one or more of data default values, values and data of combo-boxes, styles, chart creations, global variables, validation rules as assertions, control behavior, workflow path choices, database queries, HTTP request parameters and URLs of HTTP requests based on XML data contained in either the workflow document or in external data sources.

5. The method of claim 4 wherein the chart creations comprise data selected, styles applied and an actual iteration over the data.

6. The method of claim 1 wherein a developer specifies that the workflow includes certain persistent variables or Extensible Markup Language (XML) data that is stored on the user equipment persistently across sessions.

7. The method of claim 1 wherein the client application executes the workflow in the user equipment independent of the server when no new XML, chart or image is accessed for a next page and communicates with the server when data is exchanged between the client application and the server.

8. The method of claim 1 wherein the application envelope further comprises one or more of a unique identification (ID) of the workflow, version information about the server and protocol version, data for the application, one or more charts rendered by the server and saved as images, a pointer to a first or next page in the workflow to tell the client application what to do next, status information and a list of available workflows if the client application has requested such a directory from the server.

9. The method of claim 1 further comprising receiving an envelope from the client, the envelope comprising one or more of version information about a protocol version and a client version, a globally unique identifier (GUID), an operating system (OS) version, a manufacturer, a screen resolution, a tablet or smartphone indicator, a username/password, a user language, event information about a last event that happened on the client, data for the application, and request information from client to the server to handle special cases.

10. The method of claim 9 wherein the envelope is encoded in JavaScript Object Notation (JSON).

11. The method of claim 1 wherein data for the application comprises one or more Extensible Markup Language (XML) files containing user input and modifications to the one or more XML files that was originally sent from the server to the client.

12. The method of claim 11 wherein XML elements and attributes in the one or more XML files are temporary.

13. The method of claim 11 wherein the application envelope ensures that XML elements and attributes in the one or more XML files exist.

14. The method of claim 11 wherein one or more XML elements and attributes in the one or more XML files are dynamically calculated.

15. The method of claim 1 wherein receiving the application description file further comprises receiving XML files/images.

16. The method of claim 11 further comprising loading one or more XML Schema Definition (XSD) documents to define a data structure of workflow XML data.

17. The method of claim 1 wherein generating the application envelope comprises removing one or more of username/password information, chart settings, uniform resource locators (URLs) for data sources and FlowForce job settings.

18. The method of claim 1 wherein the application envelope comprises:
interpretedable user interface elements for the targeted application platforms;
interpretedable workflow definitions representing the application in the server and the application platforms; and
user equipment.

19. The method of claim 1 wherein the client application is a mobile application in the user equipment.

20. The method of claim 1 wherein the client application is a HyperText Markup Language (HTML) browser in the user equipment.

21. The method of claim 1 wherein the workflow definitions comprise a group selected from loading and saving of data files, executing workflow jobs on a separate workflow server (FlowForce), branches in the workflow via XPath expressions, event handling within a page and in the workflow between pages), and grouping of pages.

22. The method of claim 1 wherein the targeted application platforms are selected from the group consisting of Android, iOS, RIM, Windows, Linux and Unix.

23. The method of claim 1 wherein the client application residing in the user equipment and the application description file residing in the server comprise layout characteristics of the user equipment.

24. The method of claim 1 wherein the user equipment is selected from the group consisting of a smartphone, a tablet computer, a hybrid smartphone/tablet computer, a personal data assistant (PDA), a netbook computer, a laptop computer, a personal computer a desktop computer, servers, wearable computers, and Google Project Glass.

25. The method of claim 1 wherein the client application and the server execute portions of the workflow.

26. The method of claim 1 wherein the server generates an application file specifically targeted at capabilities of the user equipment reported to the server by the client application.

27. The method of claim 1 wherein the server renders charts and images for the client application in response to the workflow and to events sent from the client application.

28. The method of claim 1 wherein the workflow includes conditional program logic that uses XML Path Language (XPath) to select.

29. The method of claim 1 wherein the server updates databases or further communicates with a workflow server responsive to receiving the envelope from the client application.

30. A method comprising:
in a design system residing in a network,
generating an application description file, the application description file capable of targeting multiple application platforms and representing a workflow of an application for user equipment communicatively linked to a server;
generating from the application description file an application envelope comprising at least a subset of the application description file; and
debugging a design of the application envelope.

31. The method of claim 30 wherein debugging the design of the application envelope comprises:
executing the application envelope in the design system; and
displaying a trace of each of the steps in the workflow, the trace comprising a location of each step in the workflow and page source corresponding to the location.

32. The method of claim 30 wherein debugging the design of the application envelope comprises:
sending the application envelope to the server;
executing the application envelope in the server; and
displaying a trace of each of the steps in the workflow, the trace comprising a location of each step in the workflow and page source corresponding to the location.

33. The method of claim 30 wherein debugging the design of the application envelope comprises:
sending the application envelope to a client application on residing in the user equipment;
executing the client application; and
displaying a trace of each of the steps in the workflow, the trace comprising a location of each step in the workflow and page source corresponding to the location.
